(19) United States
(12) Patent Application Publication
(10) Pub. No.: US 2017/0124268 A1
(43) Pub. Date: May 4, 2017

(54) SYSTEM AND METHOD TO ASSIST PATIENTS AND CLINICIANS IN USING A SHARED AND PATIENT-CENTRIC DECISION SUPPORT TOOL

(71) Applicant: KONINKLIJKE PHILIPS N.V., EINDHOVEN (NL)

(72) Inventors: JINGYU ZHANG, ELMSFORD, NY (US); Pavankumar Murli DADLANI MAHTANI, EINDHOVEN (NL)

(21) Appl. No.: 15/316,865

(22) PCT Filed: Jun. 10, 2015
(86) PCT No.: PCT/IB2015/054370

§ 371 Date: Dec. 7, 2016

Related U.S. Application Data
(60) Provisional application No. 62/016,873, filed on Jun. 25, 2014.

(51) Int. Cl. G06F 19/00

(52) U.S. Cl. CPC G06F 19/345; G06F 19/3406

(57) ABSTRACT

A system (10) for multi-stage shared decision making includes a patient decision data store (60) that stores patient preferences (66) and patient rationales (68) associated with a decision regarding a first stage (64) of a treatment pathway (62). The system (10) further includes a support tool assistance system (20) that educates the patient regarding the stored preferences (66), rationales (68) and the treatment pathway (62) for making a decision regarding a next stage of the treatment pathway (62). An understanding score is calculated based on testing of the patient relative to the literacy level (72) of the patient regarding the preferences (66), rationales (68) and treatment pathway (62). Scores below a threshold score (74) result in updating educational materials for the patient, reeducation and retesting. Once the score meets the threshold (74), the patient is allowed to proceed to the next stage of decision making on the treatment pathway (62).

The following relates generally to clinician and patient decision making. It finds particular application in conjunction with systems and methods for assisting clinicians and patients in utilizing a patient-centric decision support tool, and will be described with particular reference thereto. However, it will be understood that it also finds application in other usage scenarios and is not necessarily limited to the aforementioned application.

Shared decision-making is an emerging trend in the interactions between patients and clinicians, particularly with respect to medical decision making on controversial treatments in which the patient's preferences are important influencing factors. Examples of decisions often influenced by the personal preferences of the patient include, treatment selection with respect to early-stage prostate and breast cancers, cancer prevention and screening decisions, and surgical versus conservative treatments for other diseases and injuries. The influence of the patient's preferences become more readily apparent, for example, when certain treatment options can adversely affect quality of life, but may have higher cure or success rates than other options with minimal quality of life impact. The preferences of the patient play a large part in the selection of a treatment.

Shared decision-making increases the patient's ability to make informed health care choices by providing the patient with tailored information on alternative options for diagnosis and treatment. In some implementations of the decision-making process, shared decision-making is performed with the help of patient decision support tools or aids. The tools and/or aids provide patients with better understanding of their respective disease status, increase the patients' relative health education and access to quality healthcare related information in an unbiased manner. Existing patient decision support tools focus on providing educational information from trusted sources to the patients, asking patients to specify their own preferences and values, and having the patients discuss with clinicians the information they obtained to reach a decision that is understood and agreed to by the patients.

For example, when a patient is diagnosed with a particular type of cancer, a team of multidisciplinary clinicians sit together and discuss the case to determine which treatment options are available. Soon after, a clinician sits together with the patient and discusses the diagnosis and available treatment options. The clinician and patient then jointly decide on a recommended treatment and patient pathway, which is based on clinical guidelines. However, this choice of treatment and pathway is generic, based on known medical practices, and does not take into account personalized information such as a patient's preferences on different quality of life impact after treatments beyond pathology, symptoms, and other common clinical parameters.

Furthermore, it is a well-known problem that patients do not fully understand what options are available to them and what the consequences of those options mean for them in particular. While current decision aids (e.g. paper-based value clarification forms, web-based tools, etc.) take into account to some extent the health outcome (including recovery and side effects) and the patient's values towards the side effects, they do not fully consider the lifestyle regime of the patient. Furthermore, these tools are manually based and disentangled to other sources of information. Additionally, many shared decisions are based on verbal discussions, which are difficult for patients to fully grasp all the information or even fully understand.

In addition, there is no interactive solution that allows patients to further personalize their treatment and clinical pathway based on personal preferences of outcome parameters (e.g. side effects, time of recovery, etc.), such that they can visually see changes of their patient pathway based on changing outcome parameters. Furthermore, there are no interactive solutions that allow a user to adjust their treatment pathway (e.g. make treatment less frequent) and view the effect of those changes on the outcome parameters.

Additionally, patients and clinicians are often faced with making difficult treatment decisions based on information collected as part of standard diagnostic procedures. As additional or new diagnostic tests become available, it is challenging to integrate this information into existing decision aids, which may help the patient and/or the clinician to determine the optimal treatment plan for the current patient.

Current shared decision-making patient support tools lack customization based on the patient's individual health literacy and memory. Generally, patients are not sufficiently empowered or feel tedious and bored about the decision support content of existing tools before each shared decision-making meeting with their clinicians.

Additionally, patients have difficulty in remembering their own preferences and rationales for earlier decisions. That is, patients generally do not remember their reasons for agreeing to a specific course of treatment. This difficulty in remembering rationales is not limited to the patient, as doctors also may fail to remember their advice or logic in advising a patient as to a particular treatment.

The failure to remember their rationales and preferences results in the physicians and patients requiring additional effort and consultation time to get to the ‘same page’ in the later-stage shared decision making in a long decision horizon (typically several years). This is because earlier and later-stage decisions need to be planned together with the patient's preferences and understanding of the disease remaining relatively consistent in order to achieve global optimal solutions throughout the entire disease management time horizon.

Furthermore, current shared patient decision-making support tools only focus on on-time decision and neglect personalized patient support for the entire long-term disease management. Patients often have trouble in remembering follow-up visits and adhering to entire treatment pathway planning. Follow-up visits and adherences to long-term treatment planning are especially crucial to conservative disease management such as active surveillance for prostate cancer, which requires multiple follow-up visits with changing treatment planning.

The following discloses a new and improved methods and systems, which overcome the above referenced issues, and others.

In accordance with one aspect, a system for multi-stage shared decision making includes a patient decision data store that stores patient preferences and patient rationales associated with a decision regarding a first stage of a treatment pathway. The system further includes a support tool assistance system that educates the patient regarding the stored patient preferences, the patient rationales and the treatment pathway for making a decision regarding a next stage of the treatment pathway.

In accordance with another aspect, a method for multi-stage shared decision making includes receiving patient preference and rationale information corresponding to a first stage of a treatment pathway, and storing the received patient preference and rationale information in an associated database. The method further includes calculating an understanding score in accordance with the stored preference and rationale information, and proceeding to a next stage of the treatment pathway in accordance with the calculated understanding score for a shared decision corresponding thereto.

In accordance with another aspect, a system for personalizing patient pathways includes one or more processors programmed to, before an initial treatment stage, receive patient data relating to a patient's medical records, receive the patient's lifestyle values and preferences from the patient, generate patient pathway and treatment options from the patient data and the patient's lifestyle values and preferences, and generate a graphical tool to evaluate and compare the choice of pathway and treatment options, and store the patient's lifestyle values and preferences and a chosen pathway and treatment option in a memory. The one or more processors are further programmed to, after the initial treatment stage, receive patient data relating to the patient's medical records reflecting the patient's medical condition after the first stage of treatments, retrieve the patient's lifestyle values and preferences from the memory, receive adjustments to the patient's lifestyle values and preferences, re-generate patient pathway and treatment options from the patient data and the patient's lifestyle values and preferences, and generate a graphical tool to evaluate and compare the chosen pathway and treatment option before the first treatment stage and the re-generated patient pathway and treatment options.

One advantage is achieving global optimal solutions throughout the entire disease management horizon.

Another advantage resides in the continuity of patient preferences and patient and physician rationales during stages of a treatment pathway.

Another advantage resides in the continuous, adaptive education of a patient regarding a disease and treatment.

Another advantage resides in multi-stage patient decision support throughout treatment.

Another advantage resides in minimizing patient confusion as to past treatment decisions.

Another advantage resides in reducing decisional regret, improving individual health literacy, reducing physician consultation time, and improving patient satisfaction during treatment.

Still further advantages will be appreciated to those of ordinary skill in the art upon reading and understanding the following detailed description.

The invention may take form in various components and arrangements of components, and in various steps and arrangement of steps. The drawings are only for purposes of illustrating the preferred embodiments and are not to be construed as limiting the invention.

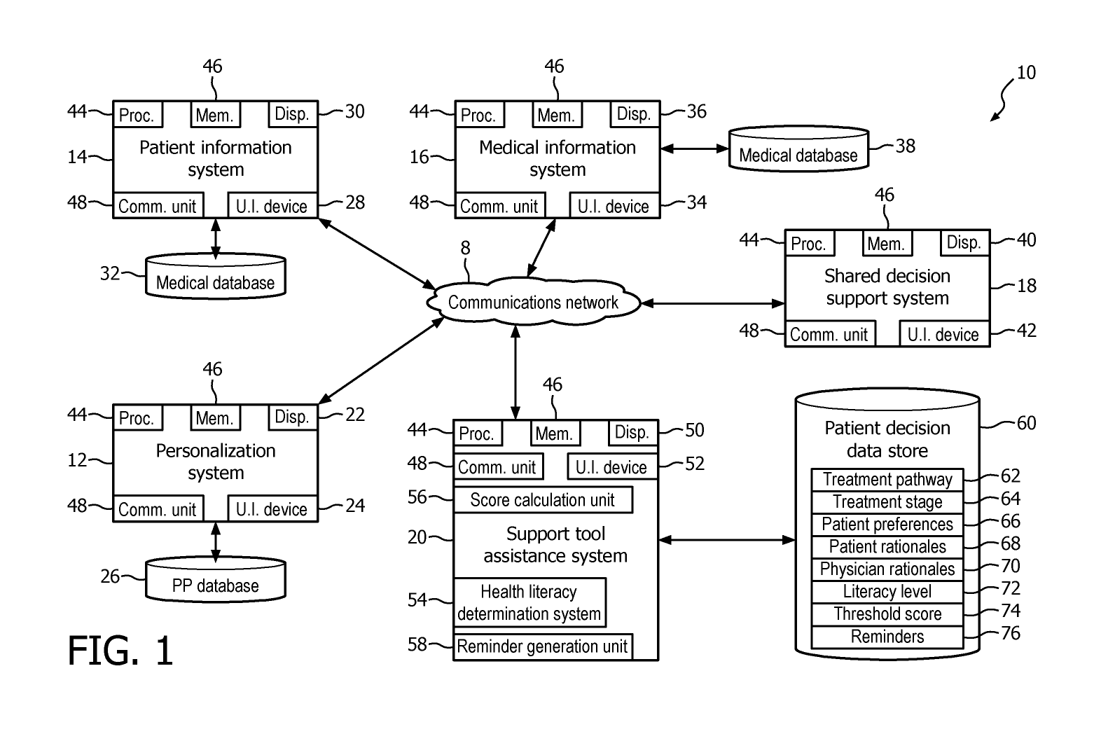

FIG. 1 is a block diagram of an information technology (IT) infrastructure in accordance with one embodiment of the subject application.

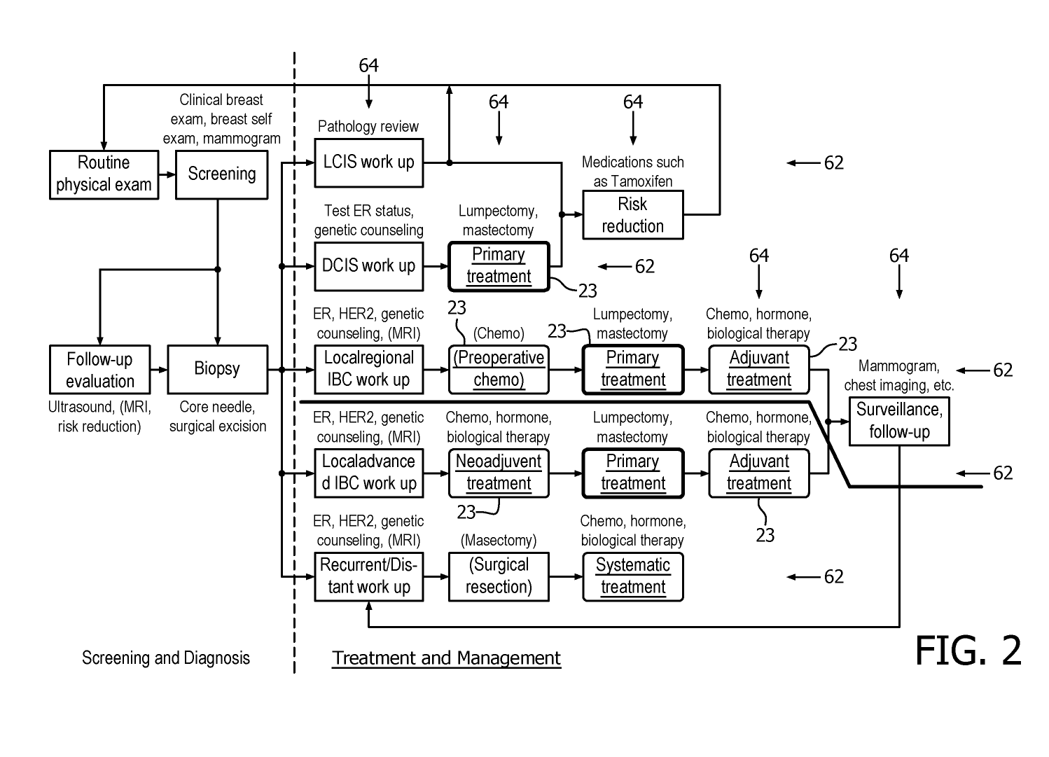

FIG. 2 schematically illustrates a care continuum of breast cancer treatment including treatment decision stages and treatment pathways.

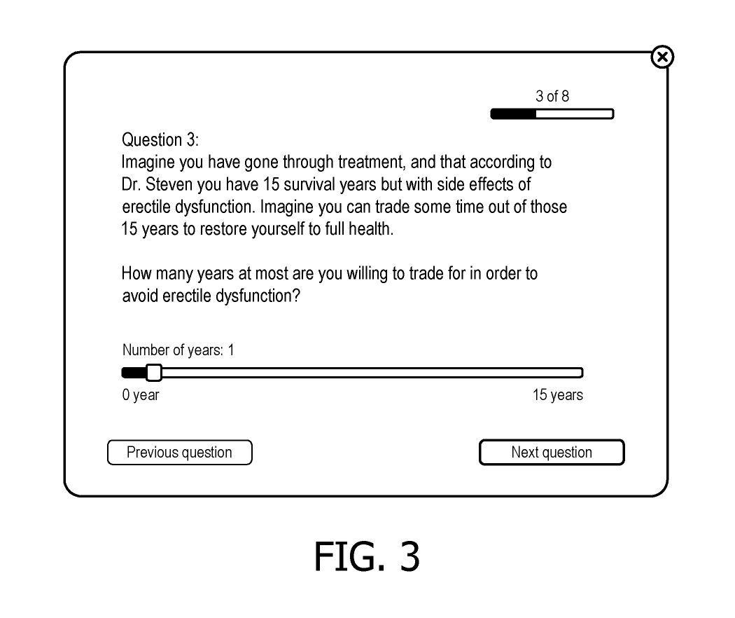

FIG. 3 is an interface depicting an example survey question for ascertaining patient preferences in accordance with one embodiment of the subject application.

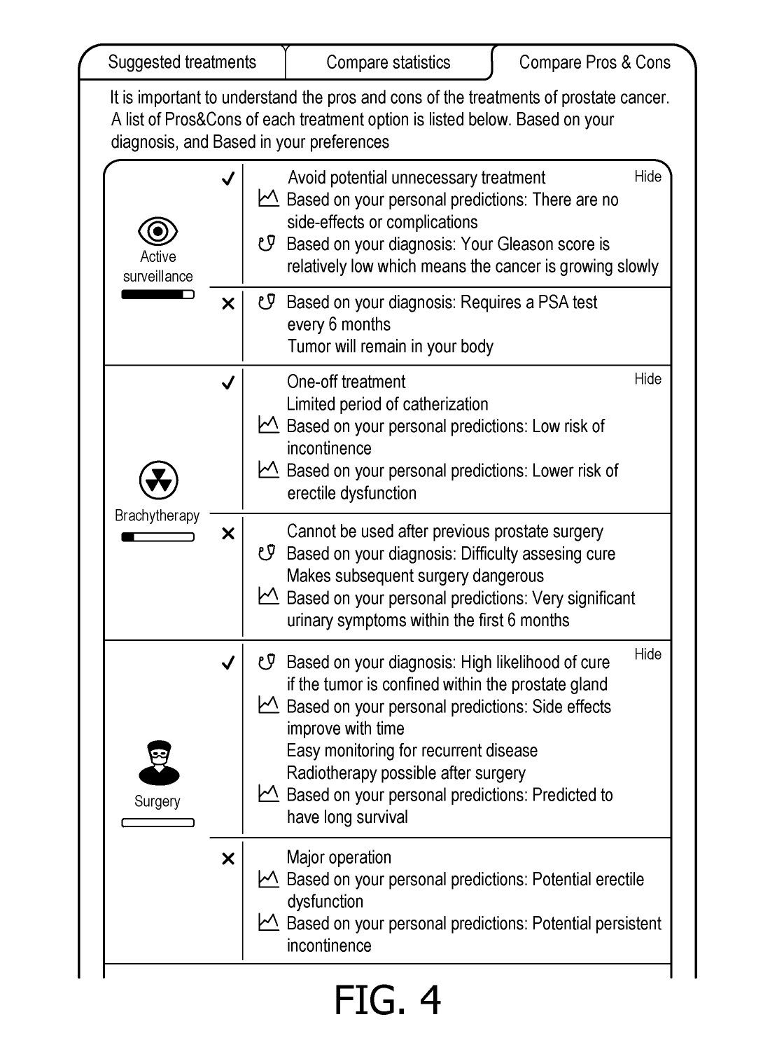

FIG. 4 illustrates an example interface of a personalized argument and rationale of an earlier-stage decision in accordance with one embodiment of the subject application.

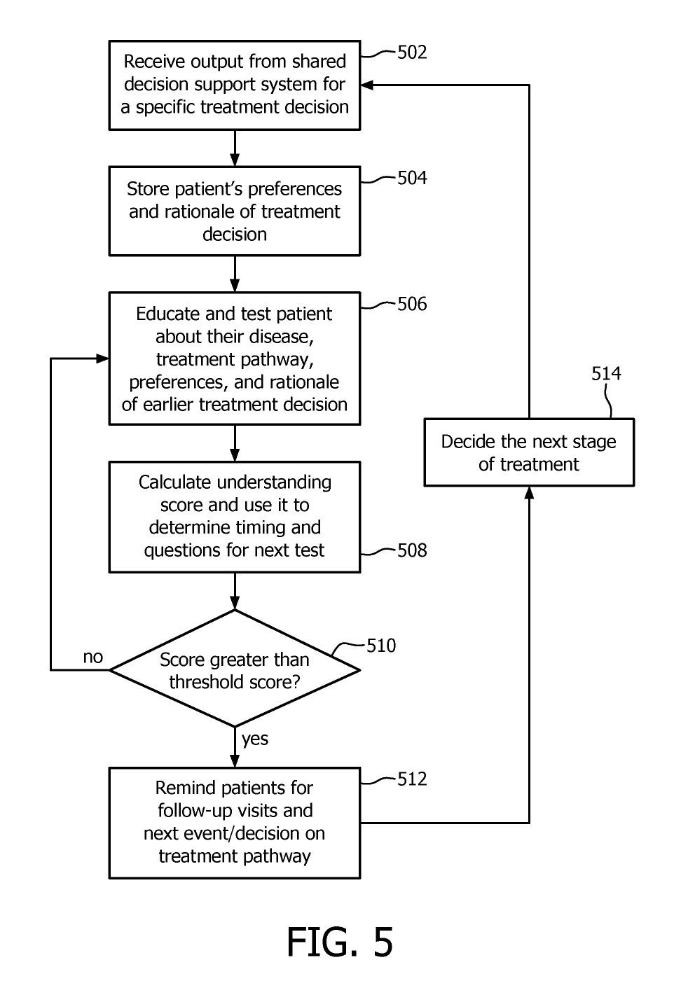

FIG. 5 flowcharts one method for multi-stage shared decision making in accordance with one embodiment of the subject application.

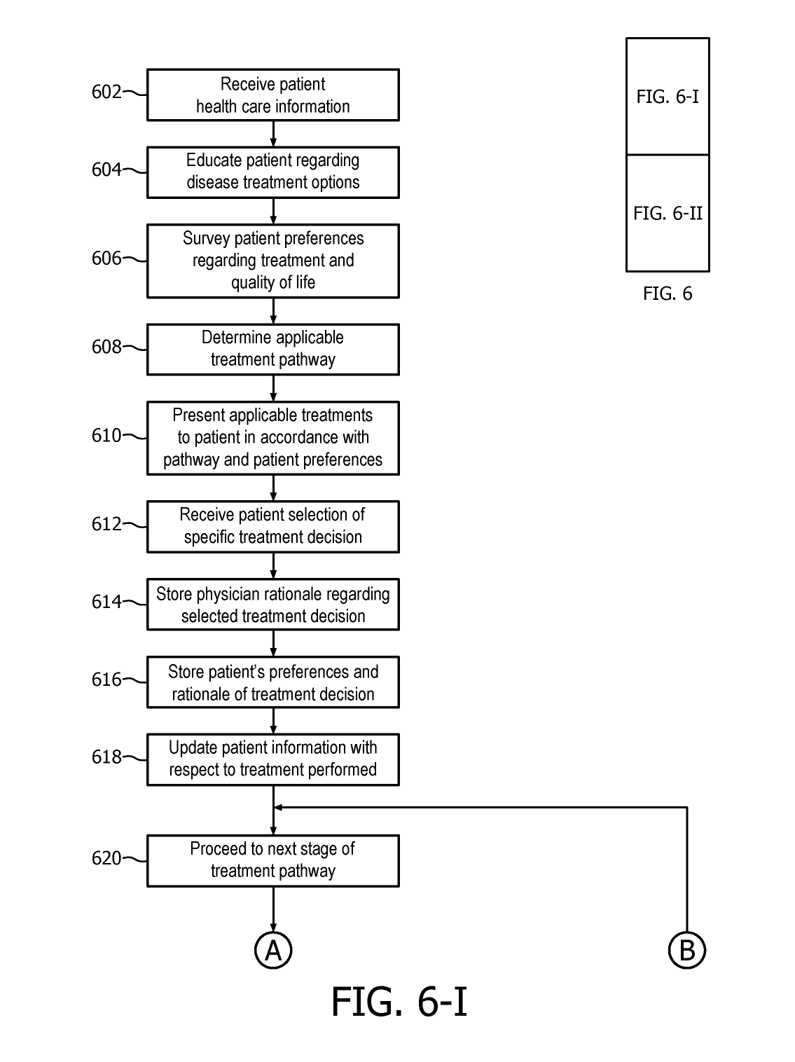

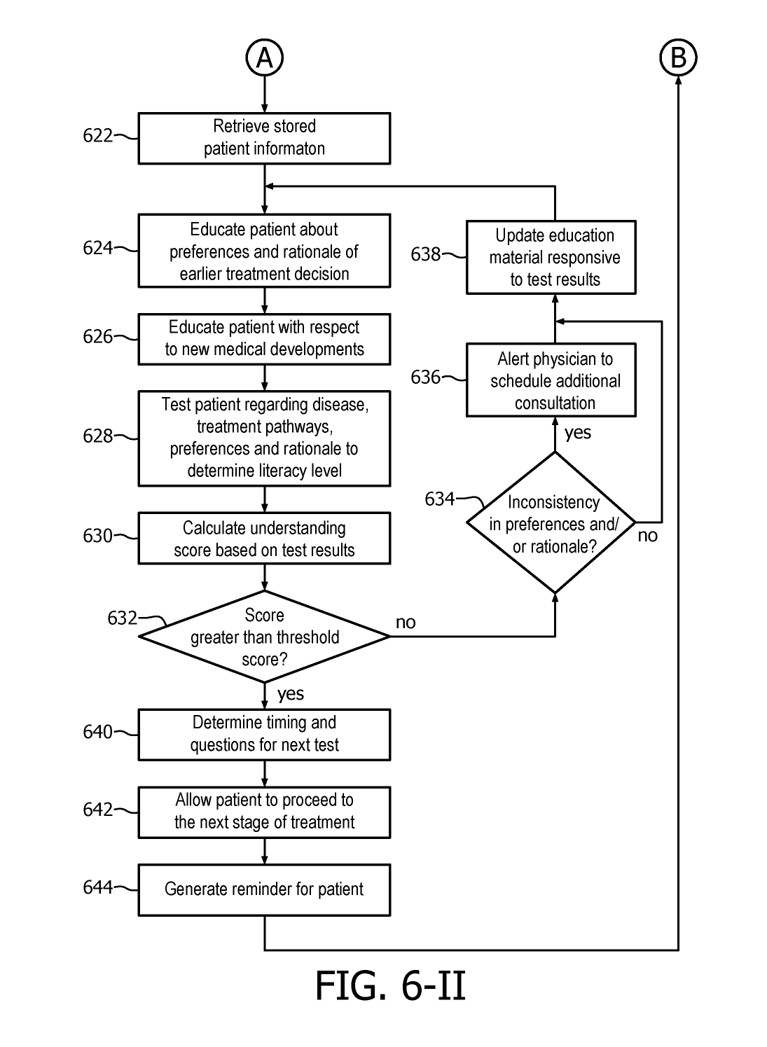

FIG. 6 flowcharts one method for multi-stage shred decision making in accordance with one embodiment of the subject application.

The present application presents a system and method to assist patients in making multi-stage shared decisions via a shared decision support system. To assist the patient, the patient's preferences and rationale in making earlier decisions are stored to minimize the patient's confusion and ease decision making for later decisions to achieve global optimal solutions throughout the entire disease management time horizon. The present application further provides the ability to customize and enhance the individual patient's learning experience according to their health literacy and memory to ensure patients are sufficiently empowered before each shared decision making meeting with their doctors.

According to one embodiment, the present application presents a system and method that enables multi-stage shared decision making via the retention of information used by the patient to make a previous decision. The retained information is reused to assist the patient and physician in deciding on the next stage of treatment. From the retained information, a shared decision support tool may ascertain the educational level of the patient with respect to the particular disease or treatments available and increase the educational level via a graphical user interface. According to one embodiment, the retention of the aforementioned information may be used to minimize patient confusion regarding past treatment and to verify patient consistency between treatments.

With reference to FIG. 1, there is shown a block diagram of a system 10 for multi-stage shared decision making using retained user preferences and rationales via a shared decision support system 18 configured to provide support to a patient in making a particular treatment decision and support tool assistance system 20 configured to assist in the utilization of the system 18 via the retention of patient information and education of the patient. The shared decision support system 18 quantitatively evaluates and compares alternative choices of diagnosis and treatment from a patient's perspective to find the best personalized medical decision. In one embodiment, the shared decision support system 18 utilizes an algorithm to convert prognosis and clinical outcomes, such as probability of mortality and morbidities, into values that are directly meaningful for the patient in evaluating and comparing different choices from the patient's perspective. The input parameters of the system 18 include patients' personal medical records, clinical evidences on outcomes and prognosis for the appropriate population, patients' values and preferences 66, and the like. The output of the system 18 may be a quantitative evaluation and comparison of the alternative choices and a simple straightforward treatment recommendation, along with the patient's rationale 68 and the physician's rationale 70 in the particular decision/recommendation. If the patient requests, the system 18 can provide additional outputs including traditional educational materials, information and access to a large patient community, probabilities of all the alternative options to be the best, confidence intervals of all the estimations, and the evidences the computation is based on. According to one embodiment, the outputs from the system 18 may be adjusted based upon a literacy level 72 of the patient via the support tool assistance system 20, as discussed below.

The shared decision support system 18 also enables patients to compare alternative choices on the same measure, such as allowing the patients to adjust for lifestyle regime and preferences, outcome parameters, patient pathways, quality-adjusted life years (QALYs), desired probability of an overall outcome or of a specific outcome parameter, and the like. The system 18 can also provide details about the sources of the parameters and the model and mathematics underlying the computation if patients are interested. The present application, via the storage of patient preferences 66 and rationales 68, as well as physician rationales 70, simplifies the shared decision making process for the patient and clinician, reduces patient's stress, increases the patient's satisfaction of their decisions, ensures and improves decision quality and continuity, reduces clinician's workload, increases quality and efficiency of the education provided to patients, increases clinician's confidence, and reduces overall healthcare costs.

The shared decision support system 18 may also quantify whether potential new information derived from an additional or new diagnostic test will help to determine the optimal treatment plan. By incorporating provider-specific treatment delivery statistics, the decision support system provides estimates of how successful the treatment plan will be for this patient with a specific care provider. The shared decision support system 18 also allows care providers to establish confidence interval limits prior to showing the results to the patient. Another option is for the care provider to assess the sources of the information used to determine the optimal treatment option to ensure that the sources are relevant to the current patient.

With reference to FIG. 1, there is shown a block diagram illustrating an embodiment of an IT infrastructure 10 of a medical institution, such as a hospital. The IT infrastructure 10 suitably includes a patient personalization system 12, a patient information system 14, one or more medical information systems 16, a shared decision support system 18, and a support tool assistance system 20, and the like, interconnected via a communications network 8. As will be appreciated, the communications network 8 may include one or more of the Internet, Intranet, a local area network, a wide area network, a wireless network, a wired network, a cellular network, a data bus, and the like. It should also be appreciated that the components of the IT infrastructure 10 may be located at a central location or at multiple remote locations.

The patient personalization system 12 enables the patient to input the patient values, lifestyle regimes, and preferences 66 related to diagnosis and treatment of the patient from a patient's perspective. The patient personalization system 12 also receives a quantitative evaluation and comparison of the alternative choices of treatment stages 64 and pathways 62 to the patient being treated in the medical institution. Various treatment pathways 62 and stages 64 are illustrated in FIG. 2 with respect to shared decisions 23 in a care continuum for breast cancer, discussed below. For example, the patient personalization system 12 displays the quantitative evaluation and comparison of the choices of treatment and pathways including a comparison of alternative choices on the same measure, such as allowing the patients to adjust for lifestyle regime and preferences, outcome parameters, patient pathways, QALYs, desired probability of an overall outcome or of a specific outcome parameter, and the like.

The patient personalization system 12 includes a display 22 such as a CRT display, a liquid crystal display, a light emitting diode display, to display the evaluation and/or comparison of choices and a user input device 24 such as a keyboard and a mouse, for the patient to input the patient's values and preferences 66 and/or modify the evaluation and/or comparison. The patient personalization system 12 may further receive a stated or selected rationale 68 associated with a particular treatment decision from the patient. The stated or selected rationale 68 may be input in the patient's own words, may be selected from a set of available rationales presented to the patient, or the like. In one embodiment, the patient values, preferences 66, and rationales 68 are stored in the patient personalization database 26. In another embodiment, the patient's preferences 66 and rationale 68 in making a particular treatment decision are stored in a patient decision data store 60, discussed in detail below. Examples of patient personalization systems 12 include, but are not limited to, a software application that could be accessed and/or displayed on a personal computer, web-based applications, tablets, mobile devices, cellular phones, and the like.

The patient information system 14 stores patient data related to the patient being treated by the medical institution. The patient data include the patient's medical records, patient demographics such as weight, age, family history, co-morbidities, etc. The patient data may also include physiological data collected from one or more sensors, physiological data, laboratory data, imaging data acquired by one or more imaging devices, the patient's administrative data, the patient's medical records, and the like. In one embodiment, the patient data includes the patient's values, lifestyles regimes, and preferences 66 stored in the patient personalization database 26. The patient data may also include physician rationales 70, physician treatment notes, comments, literacy scores 72, etc. The patient data may be generated automatically, may be input manually, or may be the result of a combination thereof. When manual input of some or all of the patient data is performed, the user input devices 28 can be employed. According to one embodiment, the patient information systems 14 include display devices 30 providing users a user interface within which to manually enter the patient data and/or for displaying generated patient data. In one embodiment, the patient data is stored in the patient information database 32. Examples of patient information systems include, but are not limited to, electronic medical record systems, departmental systems, and the like.

The infrastructure 10 of FIG. 1 further includes the medical information system 16 that stores medical data collected from a population that is related to the patient being treated. For example, the medical information system 16 stores population level medical data relating to various clinical problems of differing populations. The medical data includes population level knowledge from literature, retrospective studies, clinical trials, clinical evidence on outcomes and prognosis, and the like. The medical data may further include current medical knowledge relating to diseases, treatment pathways, testing information related to patient knowledge levels, health literacy information, threshold scores, reminders, and the like. The medical data may be generated automatically, manually, or a combination thereof. When being input manually, for example, the system 16 may utilize the user input devices 34. In accordance with one embodiment, the medical information systems 16 include display devices 36, which provide users a user interface within which to manually enter the medical data and/or for displaying generated medical data. In one embodiment, the medical data is stored in the medical database 38. In another embodiment, the patient data is also stored in the medical database 38. Examples of medical information systems include, but are not limited to, medical literature databases, medical trial and research databases, regional and national medical systems, and the like. Some or all of the medical data may be stored on a patient decision data store 60, as discussed below.

In accordance with one embodiment, the shared decision support system 18 stores clinical models and algorithms embodying the clinical support tools or patient decisions aids. The clinical models and algorithms typically include one or more diagnosis and/or treatment options as a function of the patient data and the clinical problem of the patient being treated. The clinical models and algorithms may further include recommendations for the various diagnosis and/or treatment options based on the state of the patient and the patient data. Specifically, the clinical models and/or guidelines are determined diagnoses and/or treatment options for patients with specific diseases or conditions based on the best available evidence, i.e., based on clinical evidence acquired through scientific method and studies, such as randomized clinical trials. After receiving patient data, the shared decision support system 18 applies the clinical model and algorithm pertinent to the clinical problem of the patient being treated. The shared decision support system 18 then provides the available diagnoses and/or treatment options based on the patient data. It should also be contemplated that as more patient data becomes available, the shared decision support system 18 updates the diagnosis and/or treatment options available to the patient. Specifically, the shared decision support system 18 acquires patient data, medical data, clinical models and algorithms, and the like and provides a quantitative evaluation and comparison of the alternative choices of treatment and pathways to the patient (e.g., FIG. 2) being treated in the medical institution. For example, the shared decision support system 18 acquires the patient's medical records from the patient information system 14, clinical evidences on outcomes and prognosis for the appropriate population from the medical information system 16, the clinical models and algorithms, patient values, lifestyle regimes, and preferences input by the patient, and displays the quantitative evaluation and comparison of the choices of treatment and pathways. The shared decision support system 18 includes a display 40 such as a CRT display, a liquid crystal display, a light emitting diode display, to display the clinical models and algorithms and a user input device 42 such as a keyboard and a mouse, for the clinician to input and/or modify the clinical models and algorithms.

The infrastructure 10 depicted in FIG. 1 further includes a support tool assistance system 20 that assists a patient in utilizing the shared decision support system 18 throughout the stages of a corresponding treatment pathway 62. In accordance with one embodiment, the support tool assistance system 20 receives an output from the shared decision support system 18 corresponding to an initial selection of a treatment decision associated with a particular treatment pathway 62 for the patient. The support tool assistance system 20 is in communication with a patient decision data store 60 that stores information relating to a patient. This patient information, in addition to the information stored in the medical database 32, the personalized database 26, and medical device database 38, relates particularly to a patient. As shown in FIG. 1, the patient decision data store may include, for example, the treatment pathway 62, the treatment stage or stages 64 completed or remaining, the patient preferences 66, the patient rationales 68 relating to past treatment decisions, the physician rationales 70, the literacy level 72 of the patient, the score threshold 74 relating to participation in the next stage of decision making, and any reminders 76 generated for the patient or physician regarding the treatment of the patient.

The patient preferences 66 may be ascertained as discussed above with respect to the shared decision support system 18. The patient rationales 68 may be automatically generated in response to patient selection of a specific treatment, may be input by the patient via the personalization system 12, or a combination thereof. It will be appreciated that the patient rationales 68 may be utilized by the support tool assistance system 20 to assist the patient in making a decision regarding the next stage 64 of treatment along the selected treatment pathway 62. For example, the patient may have based an earlier treatment decision on an upcoming event, selecting a less invasive procedure to allow participation in such an event. Having this information when the next, substantially invasive procedure must be decided upon can help the patient understand why this next procedure may be so drastic. Furthermore, the patient may be reminded of their rationale to help in determining the next stage 64 of treatment. The literacy level 72 of the patient corresponds to the amount of information and understanding they have regarding their particular disease, treatment pathway 62, medical advances, treatment stages 64, and the like. The support tool assistance system 20 may be configured to facilitate this determination of patient literacy 72 via a health literacy determination system 54.

The health literacy determination system 54 may be configured to educate the patient regarding the particulars of the disease being treated, the current state of the art regarding treatment, the various stages 64 of the selected treatment pathway 62, and the like. The health literacy 72 of the patient may be determined using questions generated in accordance with the particular disease and treatment pathway 64. In accordance with one embodiment, the health literacy determination system 54, via a corresponding graphical user interface, may present short tests about the patient's disease profile and possible future treatment pathways 64 and decisions to ensure and test the patient's understanding. The questions contained in the aforementioned test may be adjusted to reflect previous errors by the patient, so as to ensure that the patient is properly prepared for participation in the next stage 64 of decision making in their treatment pathway 62.

The support tool assistance system 20 may further include a score calculation unit 56 configured to analyze answers submitted by a patient in response to the health literacy determination system 54. The score generated by the calculation unit 56 may be compared to the score threshold 74 to assist the support tool assistance system 20 in determining whether the patient is sufficiently educated and ready to participate in making a decision regarding the next stage 64 of treatment. The score calculation unit 56 may utilize various inputs in determining a score associated with the patient. The score calculation unit 56 may calculate a score that estimates the patient's personal understanding of their own disease, their preferences 66, and their rationale 68 for earlier treatment decisions. According to one embodiment, this score gradually decreases as the patient forgets according to a forgetting curve. This score may be Bayesian updated based on the patient's previous test history, i.e., patients who score high in previous tests are less likely to be tested again to maintain their personal-disease-specific knowledge understanding level or health literacy 72. For example, the score calculation unit 56 may be configured to detect and recognize when inconsistencies occur between a patient's earlier preferences 66 and rationales 68 for a past treatment decision relative to the next stage 64 of treatment. When inconsistencies are detected, a physician may be notified that the patient requires additional consultation and advice regarding their disease and/or treatment.

In one embodiment, the support tool assistance system 20 includes a reminder generation unit 58 configured to generate reminders and/or notifications regarding stages 64 of treatment for the patient. The reminder generation unit 58 may be configured to send electronic mail messages, calendar notices, automated calling, or other suitable notification means to the patient and/or physician regarding upcoming decisions or treatments that need to be made or performed. Such reminders 76 may be stored in the patient decision data store 60 upon generation or after communication to the patient. The support tool assistance system 20 includes a display 50 such as a CRT display, a liquid crystal display, a light emitting diode display, to display the clinical models and algorithms and a user input device 52 such as a keyboard and a mouse, for the patient to input and/or modify the patient preferences 66, the patient rationales 68, answer testing questions from the health literacy determination system 54, and interact with the shared decision support system 18.

The components of the IT infrastructure 10 suitably include processors 44 executing computer executable instructions embodying the foregoing functionality, where the computer executable instructions are stored on memories 46 associated with the processors 44. It will be appreciated that at least some of the foregoing functionality can be implemented in hardware without the use of processors. For example, analog circuitry can be employed. Further, the components of the IT infrastructure 10 include communication units 48 providing the processors 44 an interface from which to communicate over the communications network 20. Even more, although the foregoing components of the IT infrastructure 10 were discretely described, it is to be appreciated that the components can be combined.

As mentioned above, the shared decision support system 18 and the support tool assistance system 20 receive recommended patient treatment pathway(s) 62 or treatment option(s) utilizing the available patient data, medical data, clinical models and algorithms, patient's preferences 66 on outcome parameters (e.g. on severity of side effects, frequency of treatment, survival prediction after treatment, risk estimation for complication after treatment, etc.), patient rationales 68 regarding decision selection, and the patient's lifestyle regime (agenda, habits, diet, exercise, risk estimations for long-term impairment and disabilities after treatment, etc.). Thus, the shared decision support system 18 and the support tool assistance system 20 utilize not only the values that the patient has on outcome parameters but further personalizes it to the patient's needs and context.

In one embodiment, the shared decision support system 18 generates a graphical tool that allows patients to visualize the tailored patient pathway(s) or treatment option(s) that were generated based on the input as described above. The graphical tool portrays visually the personalized patient pathway(s) and visual trends on the health outcome for each (or the selected) pathway or treatment option, including the time of recovery, the consequences (e.g. physical, mental, emotional), the frequency and regime of the treatment, the main lifestyle changes and other adverse effects (e.g. dietary, sleep, tiredness, sex life, etc.). In a further embodiment, the patient is able to have control and further personalize the graphical tool by graphically adjusting any one of the above parameters to visualize the effect of that change on the trends of the other outcome parameters and on the patient pathway. Alternatively, the user can graphically adjust the pathway and view the effects of that change on the trends of all outcome parameters.

The graphical tool also portrays the probability of overall outcome based on available medical evidence from the medical data and the clinical models and algorithms. In one embodiment, the patient is able to adjust the probability of outcome and see the effect of change on all parameters and patient pathways. In addition to the probability of overall outcome, other probabilities (based on available evidence) of specific outcome parameters can be added: e.g. likelihood of the specific trend of decline in physical energy, likelihood of the recovery, likelihood of physical pain, etc. Additional information can also be shown of how frequent or practiced the particular patient pathway is, which can also be adjusted by the patient to view for example the most frequent pathway used. In the case where the available evidence is not available for that particular probability value(s), the system automatically searches for the nearest available evidence and indicates it to the user.

In another embodiment, the graphical tool allows patients to visually explore the outcome parameters of a particular patient pathway or treatment option over time, i.e., recovery of the cancer and side effects. Patients can either click at any particular point on the visual patient pathway or adjust a specific visual control tool (e.g. a visual slider over time) to visualize e.g. the size/spread of the cancer; visualize the side effects such as amount of hair loss, etc. Furthermore, the visuals can be coupled with a probability of such outcome, such that the user is able to adjust the probability value and view the changed visuals.

Specifically, in one embodiment, the shared decision support system 18 translates prognosis and clinical outcomes such as probabilities of mortality and different morbidities into quantitative decision evaluation and comparison from the patient perspective. The evaluation relies on the available patient data, medical data, clinical models and algorithms, patient's preferences on outcome parameters, the patient's lifestyle regime, and the like. In another embodiment, the shared decision support system 18 enables patients to evaluate and compare alternative decision choices using the same measure combining length of survival and quality of life according to their own preference. This leads to a direct, simple, personal, and quantitative decision support tool for the patients. In another embodiment, the shared decision support system 18 also provides details about the sources of the parameters, the way of calculation if patients are interested, and any other related educational materials. For example, the shared decision support system 18 provides more quantitative evaluations and comparisons of different alternative choices and decision support that can directly help the patient easily answer the difficult questions they face. The choices are evaluated in terms of QALYs which consider both length of survival and quality of life from the patient perspective and the confidence intervals.

To accomplish this, the shared decision support system 18 utilizes the patient data, clinical models and algorithms, medical data, and the like to compute optimal patient pathways and/or treatment options for the patient given their current condition. Specifically, the clinical model and algorithm are applied to the patient to determine the available patient pathways and/or treatments. The patient's preferences, lifestyle regimes, and values are then utilized in estimating the parameters for computing a comparable measure that trades off survival and quality of life for each of the pathways and/or treatment options based on the medical data of related populations.

The key role of personal preference and value assessment is to understand the patient's preference and make the best use of these preferences in the decision making process. For example, a survey or questionnaire determines the preference by trading off time of living in perfect health and living with different impairments. FIG. 3 provides an example illustration of a survey presented to the patient to ascertain patient preferences 66 in accordance with one embodiment. The time-trade-off survey results in a personalized and comparable measure, quality of life, for different impairments or disabilities. Furthermore, the integral of quality of life over time results in a comparable measure, QALY, which enables patients and physicians to directly compare different choices according to the patient's own preference. The aforementioned operations of the shared decision support system 18 are further augmented by the support tool assistance system 20, described above. As the patient interacts with the shared decision support system 18 during subsequent stages 64 of treatment, the patient is reminded of past decisions, previous preferences 66 and rationales 68 that the patient used in making those decisions.

During or after treatment, patients can enter subjective data (e.g. fill in questionnaires) or patient reported outcomes, and clinicians can enter progress information with regard to the ailment (e.g. tumor reduction size), to compare how effective the treatment is (chosen patient pathway) compared to the expected recovery and side effects based on available evidence, to further understand and even graphically visualize the effectiveness and progress of the treatment. This can be done at any particular point in the patient pathway, once treatment has been initiated. For example, imaging results or patient data at different points or stages of treatment can be uploaded to the system and used to make a comparison with the expected outcome (images or pictures stored in the knowledge base of medical evidence) and produce a treatment effectiveness or progress score. Using patient reported outcome data, the system can visually portray differences between the actual trends of recovery and side effects, and the expected trends based on available evidence.

For all the different options, the shared decision support system 18 also estimates clinical outcomes such as probability of death and probabilities of morbidities based on the patient's disease status utilizing the clinical models and algorithms and medical data. To accomplish this, the shared decision support system 18 assesses the QALY outcomes of different morbidities according to patient's preference and value. The QALY outcomes of different decision choices of the patients are then evaluated. These QALY outcomes are quantitative, comparable, and personalized and presented to the patient. To avoid overwhelming patients, the results and the evidence can be provided at different levels. For example, in one embodiment, the most direct result (i.e., the expected QALYs of the different treatments) is displayed with other details available if the patients are interested. In another embodiment, the expected QALYs and corresponding confidence intervals are computed under different alternative actions for the patients given their current condition according the medical data and clinical models and algorithms. In another embodiment, the confidence interval of the expected QALYs is computer via stochastic sensitivity analysis. It should be appreciated that unlike the probability of mortality, which is traditionally a focus of clinical research and can be usually found from literature for different population, probabilities of impairments/disabilities are computed from the probabilities of complications or side effects of each specific alternative action to choose. Risks of mortality and morbidities can be obtained by either counting patients in the longitudinal dataset from the clinical provider or directly using values provided in the medical literature for the population to which the patient belongs.

In another embodiment, the shared decision support system 18 provides additional diagnostic tests and/or provider-specific treatment delivery statistics into the patient personalized decision making process. Decision support tools use a set of standard diagnostic tests (digital rectal exam (DRE), Gleason Score, Prostate-Specific Antigen (PSA) test and tumor grade) that reflect the most impactful independent parameters that the available evidence on treatment outcomes was generated upon. With “advanced” or otherwise additional diagnostic tests being available to further specify a patient's precondition, and/or with provider-specific treatment delivery statistics instead of general outcomes from literature, the discrimination between the therapeutic alternatives is improved (e.g., in terms of narrower confidence intervals for the outcome predictions) that would then make some or all alternatives distinctively ranked. For example, the “advanced” diagnostic tests may include Dx (m-p) MRI, image-fusion, ultrasound elastography, HistoScan, PCA3, and the like. In the event that confidence intervals cannot be narrowed enough to provide additional discriminatory power of treatment options, the shared decision support system 18 can inform the patient that these additional advanced tests are unnecessary for the specific patient.

In a further embodiment, the shared decision support system 18 enables the care provider to adjust the confidence interval limits to adjust for difficult to capture information about the patient that would change the ranking of the treatment options. For example, if the patient had prior radiation therapy for a different tumor, then radiation therapy would not be an option for the current patient, regardless of the ranking from the model. The shared decision support system 18 also enables the care provider to assess the suitability of the references used for estimating the optimal treatment options for a patient. For example, if the patient were located in a particular geographical region that differs significantly from the geographical region where the source data are collected, then it would be inappropriate to recommend a treatment option to the patient based on that data.

The shared decision support system 18 further provides information relating to additional testing and predicting how such additional testing can support the decision by modelling the narrowing of confidence intervals of outcome measures based on data on accuracy and precision of the test from available evidence, to make its predictive power actionable in the decision making process. For example, if doing diagnostic test X beyond the standard diagnostic tests provides new evidence that treatment Q will be more effective on the patient than treatments R or S, it is worthwhile to proceed with diagnostic test X.

In another embodiment, the shared decision support system 18 utilizes provider-specific treatment delivery statistics instead of general statistics from the literature to reduce the confidence interval overlaps of treatment options to provide patients a provider-specific treatment decision support. This enables a care provider to adjust the confidence interval limits to account for intangible or difficult to capture information about the patient. The care provider also has the authority to assess the usefulness of the source data used to develop the model that estimates the optimal treatment option for the current patient.

To accomplish such functionality, medical information system 16 stores information relating to an institution providing health advice (potentially among diagnostic and therapeutic services through healthcare professionals), applicable and available evidence in the form of a statistical or optimization model of the path of the patient's disease given certain health choices, and a computational decision aid application that is provided with data on the patient's preferences, preconditions and findings. The medical information system 16 further stores available evidence on alternative diagnostic or therapeutic methods that were not included in said the previous discussed statistical or optimization model, where this added evidence allows to the shared decision support system 18 to compare the alternative methods to the ones employed in the previous discussed statistical model with regard to their accuracy and precision to inform the calculations within the model.

This comparison provided by the shared decision support system 18 allows an estimate with potentially reduced variance of the outcome estimates that the statistical or optimization model predicts for each treatment choice based on the “standard” tests employed by the model if a particular or some “advanced” tests not included in the model but quantitatively comparable with the standard tests on accuracy, precision and predictive value would be applied. This functionality is made available to the user of the decision aid by the user interface element that allows to “evaluate the distinctive effect of additional tests”, where the user can select a test or set of tests and see how the confidence intervals of the outcome predictions change (if they get narrower, the user might want to apply the test, otherwise the test is proven to be unnecessary).

Like an effective additional diagnostic test, provider-specific treatment delivery statistics can also improve the accuracy of outcome estimation. The provider-specific statistics may be obtained from insurance providers or the hospital/facility where the provider regularly performs the procedures of interest and the like. These statistics may include the severity of illness of the patient population that the provider generally treats, the rate of unpreventable complications due to patients' co-morbidities, among other factors. For example, some providers specialize in treating patients with specific co-morbidities, so if the patient has that co-morbidity, it could be beneficial to be treated by that provider.

In another embodiment, the user (e.g. patient or healthcare professional) gets to specify the acceptable confidence intervals or to set an acceptable level of ‘overlap’ for the outcomes of the individual treatment choices, and the shared decision support system 18 chooses which additional tests would allow that. Basically this is the reverse of the approach described above: instead of ‘if you do advanced diagnostic test A, then J is the outcome and you narrow the confidence interval by Y %’, it would allow users to set ‘I want to reduce overlap, what advanced diagnostic tests do I need to do?’, or ‘the maximum range of the confidence interval that I am willing to live with is +/−X %, what are options should I consider?’, ‘or the maximum acceptable overlap is Z %, what additional diagnostic tests should be done to get closest to achieve this?’. This would assume there are several new advanced diagnostic tests. While eliminating overlap in estimates of recommended treatment options may be difficult or impossible to achieve, reducing the overlap may be a satisfactory alternative. A response from the shared decision support system 18 may be that no additional tests can reduce the overlap in estimates of recommended treatment options, and this would be a valid response from the system.

In yet another embodiment, other factors like additional costs per advanced diagnostic test might be taken into account. In another embodiment, the care provider can adjust the acceptable confidence intervals for patient prior to sharing the patient decision aid with the patient to account for intangible or difficult to capture personal information about the patient. In another embodiment, the care provider can assess the relevance of the source data used in the model that ranks the optimal treatment options for the current patient to ensure that only the most accurate and relevant information is used.

The support tool assistance system 20 provides a supplemental graphical user interface to the patient while interacting with the shared decision support system 18. FIG. 4 provides an illustration of a patient's earlier made decision, e.g., the preferences 66 and rationales 68 utilized in making such an earlier decision. The support tool assistance system 20 may then cooperate with the shared decision support system 18 in conducting a survey (as shown in FIG. 3) to ascertain the patient's current preferences 66, the patient's current health literacy, and the like. Once this additional information is gathered, the support tool assistance system 20, via the score calculation unit 56, calculates an understanding score that estimates the patient's understanding of their own disease, treatment, preferences 66 and rationales 68, and previous decisions. This score is then compared to a threshold score that indicates whether the patient is ready to participate in the next decision stage 64 of their treatment. When the score of the patient exceeds this threshold, the patient and doctor may utilize the shared decision support system (as described above) to determine the next course of action (e.g., lumpectomy or mastectomy) in the next stage 64 of the treatment pathway 62. In the event that the patient's score falls below this threshold, the patient may be presented with additional educational materials and testing to further strengthen the patient's understanding or a physician may be notified that further consultation may be required. It will be appreciated that while illustrated in FIG. 1 as separate components of the infrastructure 10, the shared decision support system 18 and the support tool assistance system 20 may be combined into a single device configured to perform the functions described herein.

A ‘computer-readable storage medium’ as used herein encompasses any tangible storage medium, which may store instructions, which are executable by a processor of a computing device. The computer-readable storage medium may be referred to as a computer-readable non-transitory storage medium. The computer-readable storage medium may also be referred to as a tangible computer-readable medium. In some embodiments, a computer-readable storage medium may also be able to store data that can be accessed by the processor of the computing device. Examples of computer-readable storage media include, but are not limited to: a floppy disk, a magnetic hard disk drive, a solid state hard disk, flash memory, a USB thumb drive, Random Access Memory (RAM), Read Only Memory (ROM), an optical disk, a magneto-optical disk, and the register file of the processor. Examples of optical disks include Compact Disks (CD) and Digital Versatile Disks (DVD), for example CD-ROM, CD-RW, CD-R, DVD-ROM, DVD-RW, or DVD-R disks. The term computer readable-storage medium also refers to various types of recording media capable of being accessed by the computer device via a network or communication link. For example, a data may be retrieved over a modem, over the internet, or over a local area network. References to a computer-readable storage medium should be interpreted as possibly being multiple computer-readable storage mediums. Various executable components of a program or programs may be stored in different locations. The computer-readable storage medium may for instance be multiple computer-readable storage medium within the same computer system. The computer-readable storage medium may also be computer-readable storage medium distributed amongst multiple computer systems or computing devices.

‘Computer memory’ or ‘memory’ is an example of a computer-readable storage medium. Computer memory is any memory that is directly accessible to a processor. Examples of computer memory include, but are not limited to: RAM memory, registers, and register files. References to ‘computer memory’ or ‘memory’ should be interpreted as possibly being multiple memories. The memory may for instance be multiple memories within the same computer system. The memory may also be multiple memories distributed amongst multiple computer systems or computing devices.

‘Computer storage’ or ‘storage’ is an example of a computer-readable storage medium. Computer storage is any non-volatile computer-readable storage medium. Examples of computer storage include, but are not limited to: a hard disk drive, a USB thumb drive, a floppy drive, a smart card, a DVD, a CD-ROM, and a solid-state hard drive. In some embodiments, computer storage may also be computer memory or vice versa. References to ‘computer storage’ or ‘storage’ should be interpreted as possibly being multiple storage. The storage may for instance be multiple storage devices within the same computer system or computing device. The storage may also be multiple storages distributed amongst multiple computer systems or computing devices.

A ‘processor’ as used herein encompasses an electronic component that is able to execute a program or machine executable instruction. References to the computing device comprising “a processor” should be interpreted as possibly containing more than one processor or processing core. The processor may for instance be a multi-core processor. A processor may also refer to a collection of processors within a single computer system or distributed amongst multiple computer systems. The term computing device should also be interpreted to possibly refer to a collection or network of computing devices each comprising a processor or processors. Many programs have their instructions performed by multiple processors that may be within the same computing device or which may even be distributed across multiple computing devices.

A ‘user interface’ as used herein is an interface that allows a user or operator to interact with a computer or computer system. A ‘user interface’ may also be referred to as a ‘human interface device.’ A user interface may provide information or data to the operator and/or receive information or data from the operator. A user interface may enable input from an operator to be received by the computer and may provide output to the user from the computer. In other words, the user interface may allow an operator to control or manipulate a computer and the interface may allow the computer indicate the effects of the operator's control or manipulation. The display of data or information on a display or a graphical user interface is an example of providing information to an operator. The receiving of data through a keyboard, mouse, trackball, touchpad, pointing stick, graphics tablet, joystick, gamepad, webcam, headset, gear sticks, steering wheel, pedals, wired glove, dance pad, remote control, and accelerometer are all examples of user interface components which enable the receiving of information or data from an operator.

A ‘hardware interface’ as used herein encompasses an interface which enables the processor of a computer system to interact with and/or control an external computing device and/or apparatus. A hardware interface may allow a processor to send control signals or instructions to an external computing device and/or apparatus. A hardware interface may also enable a processor to exchange data with an external computing device and/or apparatus. Examples of a hardware interface include, but are not limited to: a universal serial bus, IEEE 1394 port, parallel port, IEEE 1284 port, serial port, RS-232 port, IEEE-488 port, Bluetooth connection, Wireless local area network connection, TCP/IP connection, Ethernet connection, control voltage interface, MIDI interface, analog input interface, and digital input interface.

A ‘display’ or ‘display device’ as used herein encompasses an output device or a user interface adapted for displaying images or data. A display may output visual, audio, and or tactile data. Examples of a display include, but are not limited to: a computer monitor, a television screen, a touch screen, tactile electronic display, Braille screen, Cathode ray tube (CRT), Storage tube, Bi-stable display, Electronic paper, Vector display, Flat panel display, Vacuum fluorescent display (VF), Light-emitting diode (LED) displays, Electroluminescent display (ELD), Plasma display panels (PDP), Liquid crystal display (LCD), Organic light-emitting diode displays (OLED), a projector, and Head-mounted display.

Each of the databases described herein, such as databases 26, 32, 38, 60, suitably include a computer database, where the computer database is embodied by a single computer, distributed across a plurality of computers, or the like. Further, each of the databases suitably stores data in a structured manner facilitating recall and access to such data. Further, as used herein, a memory includes one or more of a non-transient computer readable storage medium; a magnetic disk or other magnetic storage medium; an optical disk or other optical storage medium; a random access memory (RAM), read-only memory (ROM), or other electronic memory device or chip or set of operatively interconnected chips; an Internet server from which the stored instructions may be retrieved via the Internet or a local area network; or so forth. Further, as used herein, a controller includes one or more of a microprocessor, a microcontroller, a graphic processing unit (GPU), an application-specific integrated circuit (ASIC), a field-programmable gate array (FPGA), and the like; a communications network includes one or more of the Internet, a local area network, a wide area network, a wireless network, a wired network, a cellular network, a data bus, such as USB and I2C, and the like; a user input device includes one or more of a mouse, a keyboard, a touch screen display, one or more buttons, one or more switches, one or more toggles, and the like; and a display includes one or more of a LCD display, an LED display, a plasma display, a projection display, a touch screen display, and the like.

FIG. 5 presents a simplified flowchart 500 of an example methodology for assisting a patient in making subsequent decisions regarding their treatment. At 502, output from the shared decision support system 18 is received by the support tool assistance system 20 for a specific treatment decision. The support tool assistance system 20 then stores, at 504, the patient preferences 66 and patient rationale 68 associated with the treatment decision. At 506, the patient is educated and tested by the support tool assistance system 20 regarding their disease, treatment pathway 64, patient preferences 66, and patient rationale 68 of their earlier decision.

The support tool assistance system 20 then calculates an understanding score for the patient at 508 and uses this score to determine the timing and questions for the next test. As discussed above, the questions presented to the patient may be adjusted in accordance with wrong answers, inconsistencies, and the like. It will be appreciated that the support tool assistance system 20 may determine that more frequent or less frequent testing of the patient's literacy 72 may be required based upon the calculated understanding score. A determination is then made at 510 whether the calculated understanding score is greater than a predetermined threshold score. In the event that the understanding score of the patient falls below the threshold, operations return to 506, whereupon the patient is reeducated and tested until the understanding score meets or exceeds the threshold.

Upon meeting or exceeding the threshold score at 510, operations proceed to 512, whereupon the patient is reminded for any follow-up visit and the next event/decision on the treatment pathway 62. Subsequently, at 514, the patient is advanced to decide the next stage 64 of treatment such that operations return to 502, whereupon the shared decision support system 18 is utilized to determine the next decision and the output is received by the support tool assistance system 20 as described above.

Turning now to FIG. 6, there is shown a detailed flowchart 600 of one expanded embodiment of operations of the support tool assistance system 20. The methodology begins at 602, whereupon patient health care information is received. The patient is then educated, at 604, regarding the various disease treatment options. The patient preferences 66 regarding treatment and quality of life are surveyed at 606, as described in detail above. The applicable treatment pathways 62 are then determined at 608 in accordance with the patient medical information and the results of the aforementioned survey, i.e., patient preferences 66. The applicable treatment pathways 62 and decisions are then presented to the patient at 610.

A patient selection of a specific treatment decision is then received at 612 corresponding to one of the treatment pathways 62 and the stage 64 of treatment requiring a decision. For example, as shown in FIG. 2, the various treatment pathways 62 for breast cancer may be presented to the patient and physician, with one of the treatment pathways 62 being selected according to a patient's specific disease profile (underlined in FIG. 2). After selecting this pathway 62, a shared decision 23 must be made regarding preoperative chemo. At 612, a shared decision 23 regarding this stage 64 of treatment is received. At 614, the physician rationale 70 associated with advising the patient regarding this particular shared decision 23 is stored in the patient decision data store 60.

At 616, the patient's preferences 66 and rationale associated with the shared decision 23 are stored in the patient decision data store 60. The patient may then be treated in accordance with the shared decision 23 on preoperative chemo. At 618, the patient information in the patient data store 60 is then updated to reflect the performance of the treatment stage 64. Operations then proceed to the next stage 64 of the treatment pathway 62 at 620. It will be appreciated that the next stage 64 of the treatment pathway 62 may occur a substantial time in the future, i.e., the preoperative chemo, depending upon the decided course, may take weeks or even months.

When it is time for a decision to be made at the next stage 64, e.g., the shared decision 23 for primary treatment (mastectomy or lumpectomy), operations proceed to 622. At 622, the patient preferences 66, patient rationale 68, physician rationale 70, and other patient medical information are retrieved from the appropriate data storage 26, 32, 38, 60. The patient is then educated at 624 about the earlier decision (preoperative chemo), their past preferences 66, the past rationales 68, etc. via a suitable graphical user interface, e.g., FIG. 4. According to one embodiment, the materials used to educate the patient at 624 may be customized as particular to that patient, i.e., specific information relating to the disease, the past treatments, the potential future treatments, and the like. In such an embodiment, the information presented to the patient for education may be based on particular health information of the patient, e.g., weight, age, current prescription interactions, and various other patient-specific data. It will be appreciated that such an enhancement of the learning experience substantially increases and improves the health literacy level 72 of the patient regarding their treatment. At 626, the patient is educated with respect to any new developments in medicine pertinent to the disease and/or treatment pathway 62. It will be appreciated that the medical database 32 or 34 may be utilized to provide the aforementioned new developments. The patient is then tested via the health literacy determination system 54 regarding their disease, past preferences 66, past rationale 68, and selected treatment pathway 62 at 628 so as to determine the current literacy level 72 associated with the patient.

An understanding score is then calculated for the patient by the score calculation unit 56 at 630 to estimate the patient's current understanding of their specific disease, the treatments available, their preferences 66, their rationale 68, and the like. At 632, a determination is made whether the calculated score is greater than a predetermined threshold score 74. Upon a determination at 632 that the calculated understanding score is below the predetermined threshold 74, operations proceed to 634, whereupon the patient's answers are analyzed to determine whether the patient preferences 66 have changed. In the event that the patient preferences 66 have changed, the patient's physician may be alerted as to the inconsistency between past preferences and current preferences at 636, enabling the physician to schedule additional consultation with the patient. The change in preferences 66 may also alert the physician to adverse side effects of past treatment, degradation in mental facilities of the patient, change in lifestyle, and the like. Additional causes of the inconsistency detected may adversely affect the patient's health, thus the physician may be notified via immediate alert, predetermined communication means, or the like.

After alerting the physician at 636, or upon a determination at 634 that no inconsistencies in preferences 66 are determined, the materials for educating the patient are updated at 638 in response to the results of the testing. For example, the education materials may be updated to concentrate on the errors, mistakes, or forgetfulness demonstrated by the patient's answers during the testing. In accordance with one embodiment, additional information pertaining to areas identified during the testing wherein the patient's health literacy 72 was low may be retrieved from corresponding databases 26, 32, 38, 60, for incorporation into the education materials to be presented to the patient. Thereafter, operations return to 624, whereupon the patient is (re)educated regarding their specific disease, past preferences 66 and rationales 68, current medical state, treatment pathway 62, and the like. Operations proceed thereafter with respect to FIG. 6 as discussed in detail above.

Returning to 632, upon a determination that the patient's calculated understanding score meets or exceeds the predetermined threshold score 74, operations proceed to 640. At 640, the timing and questions for the next test of the patient relating to the following stage 64 of treatment (e.g., the adjuvant treatment) are determined. The patient is then allowed to proceed to the decision making for the next stage of treatment 64, i.e., the primary treatment, at 642. A reminder 76 is generated for the patient regarding the following treatment (adjuvant treatment) at 644, whereupon operations with respect to FIG. 6 return to 612 for selection of the specific treatment decision, e.g., lumpectomy or mastectomy. That is, a reminder is generated for the patient corresponding to the next event or decision to be made on the treatment pathway 62. Operations continue thereafter for the entirety of the selected treatment pathway 62. It will be appreciated that while the example provided in FIG. 6 follow a single treatment pathway 62, medical necessity may force deviation to another pathway, i.e., cancer is more invasive than anticipated, the cancer has spread to other body parts/systems, etc. Upon such an occurrence, the systems and methods presented herein are capable of adaptation to educate and evaluate the patient, the patient preferences, and the like, throughout.

It is to be appreciated that in connection with the particular illustrative embodiments presented herein certain structural and/or function features are described as being incorporated in defined elements and/or components. It will be appreciated that these features may also likewise be incorporated in other elements and/or components where appropriate, to the same or similar benefit. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof. That is to say, it will be appreciated that various of the above-disclosed and other features and functions, or alternatives thereof, may be desirably combined into many other different systems or applications, and also that various presently unforeseen or unanticipated alternatives, modifications, variations or improvements therein may be subsequently made by those skilled in the art which are similarly intended to be encompassed by the following claims.

1. A system for multi-stage shared decision making, comprising:
a patient decision data store for storing patient preferences and patient rationales associated with a decision regarding a first stage of a treatment pathway; and
a support tool assistance system configured for educating the patient regarding the stored patient preferences, the patient rationales and the treatment pathway for making a decision regarding a next stage of the treatment pathway.

2. The system according to claim 1, further comprising:
a health literacy determination system configured for:
testing the patient regarding the patient preferences, the patient rationales, a disease being treated, and the treatment pathway prior to making the decision regarding the next stage of the treatment pathway, and
determining a health literacy level in response to an output of the testing.

3. The system according to claim 2, further comprising:
a score calculation unit for calculating an understanding score of the patient regarding the determined health literacy level.

4. The system according to claim 3, wherein the support tool assistance system reeducates the patient responsive to the calculated understanding score being less than a threshold score.

5. (canceled)

6. The system according to claim 3, wherein the support tool assistance system updates education materials in response to the determined health literacy level and at least one patient response to the testing by the health literacy determination system.

7. The system according to claim 3, wherein the support tool assistance system compares the calculated understanding score to a threshold score, wherein the decision regarding the next stage of the treatment pathway is allowed to be made in accordance with the understanding score greater than the threshold score.

8. The system according to claim 1, wherein educating the patient by the support tool assistance system further includes generating graphical user interface depicting the stored patient preferences, the stored patient rationales, and at least one treatment corresponding to the treatment pathway.

9. (canceled)

10. The system according to claim 1, further comprising:
a shared decision support system for receiving the patient preferences and the patient rationales while assisting the patient in making the decision regarding the first stage of the treatment pathway.

11. A method for multi-stage shared decision making, comprising:
receiving patient preference and rationale information corresponding to a first stage of a treatment pathway;
storing received patient preference and rationale information in an associated database;
calculating an understanding score in accordance with the stored preference and rationale information,
deciding a next stage of the treatment pathway in accordance with the calculated understanding score for a shared decision corresponding thereto; and
retrieving the stored patient preference and the rationale information from the associated database;
educating the patient in accordance with the retrieved patient preference and the retrieved rationale information and apt least one of a new medical development, a disease, or the treatment pathway.

12. (canceled)

13. The method according to of claim 11, further comprising:
testing the patient to determine a literacy level of the patient with respect to at least one of the preferences, the rationales, or the treatment pathway;
calculating the understanding score in accordance with the determined literacy level; and
comparing the calculated understanding score to a predetermined threshold score,
wherein proceeding to the next stage is in accordance with the calculated score being greater than or equal to the threshold score.

14. The method according to claim 11, further comprising:
determining an inconsistency in at least one of the preferences or the rationales responsive to the calculated understanding score being less than the threshold score; and
alerting a physician to schedule consultation responsive to the determined inconsistency.

15. The method according to claim 13, further comprising:
updating education materials for educating the patient in response to the testing.

16. The method according to claim 11, wherein the patient preferences or patient rationales are determined in accordance with a survey corresponding to at least one of a treatment and a quality of life associated with the patient.

17. The method according to claim 11, wherein educating the patient by the support tool assistance system further includes generating graphical user interface depicting the stored patient preferences, the stored patient rationales, and at least one treatment corresponding to the treatment pathway.

18. A non-transitory computer-readable storage medium carrying software which controls one or more electronic data processing devices to perform the method according to claim 11.

19. (canceled)

20. (canceled)
